(19) United States
(12) Patent Application Publication
(10) Pub. No.: US 2026/0355826 A1
(43) Pub. Date: Nov. 12, 2026

(54) DEVICE FOR LASER COAXIAL WIRE ADDITIVE MANUFACTURING IN A SIMULATED MICROGRAVITY ENVIRONMENT AND METHOD FOR OPERATING THE SAME

(71) Applicant: NANJING UNIVERSITY OF AERONAUTICS AND ASTRONAUTICS, Nanjing (CN)

(72) Inventors: Xiaohong ZHAN, Nanjing (CN); Kaiyu ZHANG, Nanjing (CN); Yuhang DUAN, Nanjing (CN); Xiong ZHANG, Nanjing (CN); Jianfeng WANG, Nanjing (CN)

(21) Appl. No.: 19/712,276

(22) Filed: Jun. 18, 2026

(30) Foreign Application Priority Data
Aug. 11, 2025 (CN) 202511113357.5

(51) Int. Cl. B22F 12/70; B22F 10/25; B22F 10/80; B22F 12/41; B22F 12/50; B22F 12/90; B33Y 10/00; B33Y 30/00; B33Y 50/00

(52) U.S. Cl. CPC B22F 12/70; B22F 10/25; B22F 10/80; B22F 12/41; B22F 12/50; B22F 12/90; B33Y 10/00; B33Y 30/00; B33Y 50/00; B22F 2201/20; B22F 2998/10

(57) ABSTRACT

A device for laser coaxial wire additive manufacturing in a simulated microgravity environment, including a main body and a coaxial wire-feeding head. A negative pressure suction structure is provided on a wire feeding nozzle. An outer side of a top of the negative pressure suction structure is provided with a plurality of liquid nitrogen flow pipes, and the negative pressure suction structure is connected with an external cooling source through the plurality of liquid nitrogen flow pipes. Multiple gas flow pipes are provided at two sides of the negative pressure suction structure, respectively. The top of the negative pressure suction structure is fixedly connected with a cooling shell through the gas flow pipes. A method for operating such device is also provided.

### CROSS-REFERENCE TO RELATED APPLICATIONS

This application claims the benefit of priority from Chinese Patent Application No. 202511113357.5, filed on Aug. 11, 2025. The content of the aforementioned application, including any intervening amendments thereto, is incorporated herein by reference in its entirety.

### TECHNICAL FIELD

This application relates to laser coaxial wire additive manufacturing devices, and more particularly to a device for laser coaxial wire additive manufacturing in a simulated microgravity environment and a method for operating the same.

### BACKGROUND

In the prior art, mainstream mature methods for simulating a microgravity environment during additive manufacturing or welding processes are mainly a drop tower method and a parabola flight method, where an apparatus falls with a gravitational acceleration g, and an entire gravity mg is used to provide the gravitational acceleration g, thereby offsetting gravity and achieving a microgravity effect.

The drop tower method: an experimental capsule is allowed to fall freely in a vacuum environment from a height of about 100-200 meters to obtain a microgravity environment lasting for about 3-5 seconds.

The parabola flight method: a modified aircraft climbs at an elevation angle of 45° and then dives along a parabolic trajectory to generate a microgravity environment lasting for about 20-30 seconds.

The drop tower method and parabola flight method for simulating the microgravity environment in additive manufacturing and welding processes have the following disadvantages.

(1) Short duration of a single microgravity simulation, leading to process discontinuity: the parabola flight method (15-30 seconds per run) and drop tower method (3-5 seconds per run) are limited by physical mechanisms, forcing experiment to be performed in segments, which cannot cover continuous process cycles such as multi-layer deposition in wire additive manufacturing, causing critical thermodynamic processes to be forcibly interrupted. For example, residual heat in a molten pool from a previous experiment, heat accumulation effect undergoes nonlinear distortion due to intermittent interruptions, and process parameters, such as dynamic matching between wire feed speed and laser power, cannot be verified under real continuous operating conditions, causing that ground experiments cannot accurately reproduce true thermodynamic boundary conditions of continuous manufacturing in space.

(2) High experimental cost and long time consumption: manufacturing cost of devices for the drop tower method and the parabola flight method are high, and the experimental cost is high. There are restrictions on size and weight of the test devices. A duration of each single experiment is short, while durations of preparation, debugging and processing are long. In order to piece together complete data, multiple short-duration experiments must be repeated, and the intermittent interruptions accumulates energy consumption and time cost.

### SUMMARY

The present disclosure is to provide a device and method for laser coaxial wire additive manufacturing in a simulated microgravity environment, so as to solve the problems mentioned in the background.

In order to achieve the above objectives, the present disclosure provides the following technical solutions.

A device for laser coaxial wire additive manufacturing in a simulated microgravity environment is provided, comprising:
a main body; and
a coaxial wire-feeding head;
wherein a negative pressure suction structure is provided on a wire feeding nozzle of the coaxial wire-feeding head; an outer side of a top of the negative pressure suction structure is provided with a plurality of liquid nitrogen flow pipes, and the negative pressure suction structure is configured to be connected with an external cooling source through the plurality of liquid nitrogen flow pipes; a plurality of gas flow pipes are respectively provided at two sides of the negative pressure suction structure, respectively; the top of the negative pressure suction structure is fixedly connected with a cooling shell through the gas flow pipe; and the cooling shell communicates an interior of the negative pressure suction structure through the plurality of gas flow pipes; and
an interior of each of the plurality of gas flow pipes is provided with a fan, and the fan is configured to generate an airflow; an inner wall of the negative pressure suction structure opposite to the fan is provided with a curved cross-sectional structure, and the curved cross-sectional structure is configured to generate an enhanced and uniform annular upward airflow at a center of the fan due to a pressure difference, so as to balance a gravity of a molten droplet falling from a welding wire.

In an embodiment, the number of the plurality of liquid nitrogen flow pipes is four, and four liquid nitrogen flow pipes are arranged on an outer side of the negative pressure suction structure in a circular array; the external cooling source is cooled nitrogen, and is configured to be introduced into the interior of the negative pressure suction structure through the four liquid nitrogen flow pipes for cooling; and the cooled nitrogen is capable of acting as a protective gas.

In an embodiment, an air inlet and an air outlet are provided on the negative pressure suction structure 6. Compressed air is configured to be allowed to enter through the air inlet, pass through a special flow channel inside the negative pressure suction structure, and flows out through the air outlet. A flow velocity at the air outlet is greatly increased so as to achieve the Bernoulli negative-pressure principle.

In an embodiment, a portion of a bottom of the negative pressure suction structure close to an inner side of the negative pressure suction structure is provided with a cooled nitrogen outlet; and the cooled nitrogen outlet is configured to be upwardly incline to generate the airflow, so as to generate a negative pressure region.

In an embodiment, the interior of the negative pressure suction structure is provided with an arc-shaped partition; the arc-shaped partition is configured to divide the negative pressure suction structure into two regions; the arc-shaped partition is provided with a plurality of pressure nozzles; and the plurality of pressure nozzles are respectively matched with the plurality of gas flow pipe in number and positions.

In an embodiment, an outer side of the arc-shaped partition is provided with a plurality of airflow regulating assemblies; and the plurality of airflow regulating assemblies are arranged between the plurality of pressure nozzles and the plurality of gas flow pipe, respectively.

In an embodiment, each of the plurality of airflow regulating assemblies comprise a first flow guide plate and a second flow guide plate movably connected with each other, and the first flow guide plate and the second flow guide plate are movably connected with an inner wall of the arc-shaped partition through a rotating shaft; a spring is sleeved outside the rotating shaft; and a first end of the spring is connected with the first flow guide plate, and a second end of the spring is connected with the second flow guide plate.

A method for operating the device above is provided, comprising:
(S1) starting the negative pressure suction structure and the fan provided in the negative pressure suction structure; introducing an external liquid nitrogen flow into the four liquid nitrogen flow pipes, so as to generate an initial negative pressure field; and determining an airflow parameter for balancing gravity according to properties of used materials;
(S2) adjusting a coaxial wire-feeding unit, a camera, and an infrared thermal imager; fixing a substrate; and determining parameters of laser coaxial wire additive manufacturing; wherein the parameters comprise a laser power, a scanning speed, a wire-feeding speed and a focal length during a process of the laser coaxial wire additive manufacturing;
(S3) focusing laser beams onto the substrate to form a molten pool; feeding a metal wire into a center of the molten pool to achieve droplet transfer and spreading in a microgravity environment simulated by a negative pressure suction field;
(S4) capturing, by the camera, processes of droplet detachment, droplet spreading and droplet solidification in real time; and monitoring, by the infrared thermal imager, a temperature field distribution of the molten pool; and
(S5) after a target structure is formed by layer-by-layer stacking, turning off a laser and wire-feeding system; and maintaining the negative pressure suction field until the molten pool is completely solidified.

The present disclosure has the following technical effects and beneficial effects.

(1) In the whole process of the present disclosure, based on Bernoulli's principle, an annular negative pressure suction field is generated in a vertical direction to balance gravity in real time, enabling long-duration, continuous, low-cost, and realistic simulation of laser wire additive manufacturing in the microgravity environment. The present disclosure includes a device integrating liquid nitrogen cooling and protective gas flow, which can counteract effects of thermal expansion caused by high temperature generated by laser heating on airflow disturbance and deformation of the negative pressure suction structure, and can also replace side-blown protective gas device to prevent oxidation during the additive manufacturing process, thereby significantly reducing the cost of experimental verification for additive manufacturing in the microgravity environment.

(2) Because the plurality of airflow regulating assemblies would bend under force when corresponding gas flow pipes are inflated, when one of the corresponding gas flow pipes is cutoff, the first flow guide plate and the second flow guide plate of the one of the corresponding gas flow pipes are reset by a spring restoring force, so that the first flow guide plate and the second flow guide plate of the plurality of airflow regulating assemblies on opposite sides of the one of the corresponding gas flow pipes that are not cutoff are pressed against the inner wall of the arc-shaped partition, directing the airflow to an inner side of reset first flow guide plate and reset second flow guide plate, that is, the airflow is directly directed to a pressure nozzle corresponding to the cutoff gas flow pipe for pressure compensation, thereby preventing unequal pressure among the plurality of pressure nozzles even when a gas flow pipe is cut off.

### BRIEF DESCRIPTION OF THE DRAWINGS

FIG. 1 is a schematic diagram of a device for laser coaxial wire additive manufacturing based on a negative pressure suction method according to an embodiment of the present disclosure.

FIG. 2 is a schematic diagram of a negative pressure suction structure according to an embodiment of the present disclosure.

FIG. 3 is a cross-sectional schematic diagram of a fan of the negative pressure suction structure according to an embodiment of the present disclosure.

FIG. 4 is a cross-sectional schematic diagram of a liquid nitrogen flow pipes according to an embodiment of the present disclosure.

FIG. 5 is a right cross-sectional of the negative pressure suction structure according to an embodiment of the present disclosure.

FIG. 6 is a principle schematic diagram of the negative pressure suction structure according to an embodiment of the present disclosure.

FIG. 7 is a three-dimensional view of negative pressure suction structure according to an embodiment of the present disclosure.

FIG. 8 is a schematic diagram of an inner structure of the negative pressure suction structure according to an embodiment of the present disclosure.

FIG. 9 is a schematic diagram of an airflow regulating assembly according to an embodiment of the present disclosure.

FIG. 10 is an enlarged view of portion “A” in FIG. 9.

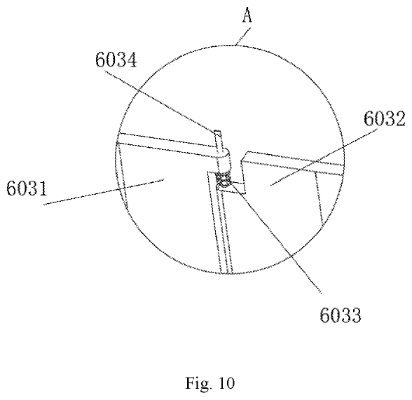

In the Figures: 1, coaxial wire-feeding head; 2, coaxial wire-feeding unit; 3, cooling shell; 4, liquid nitrogen flow pipe; 5, gas flow pipe; 6, negative pressure suction structure; 7, fan; 8, curved cross-sectional structure; 601, arc-shaped partition; 602, pressure nozzle; 603, airflow regulating assembly; 6031, first flow guide plate; 6032, second flow guide plate; 6033, spring; and 6034, rotating shaft.

### DETAILED DESCRIPTION OF EMBODIMENTS

The technical solutions of the embodiments of the present disclosure will be clearly and completely described with reference to the accompanying drawings of the embodiments of the present disclosure. It is obvious that described herein are only some embodiments of the present disclosure, rather than all embodiments. Based on the embodiments of the present disclosure, other embodiments obtained by those of ordinary skill in the art without making creative effort shall fall within the scope of the present disclosure.

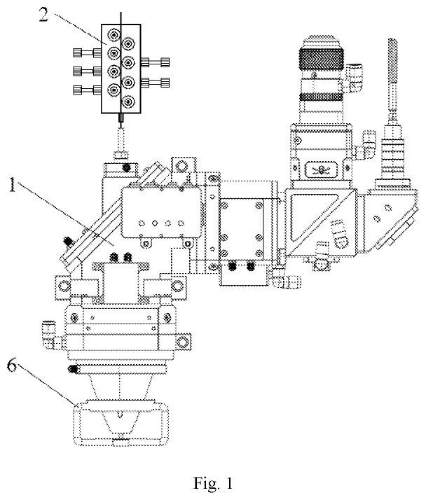

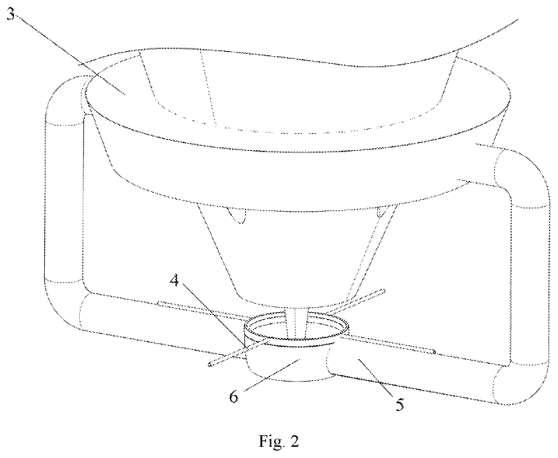

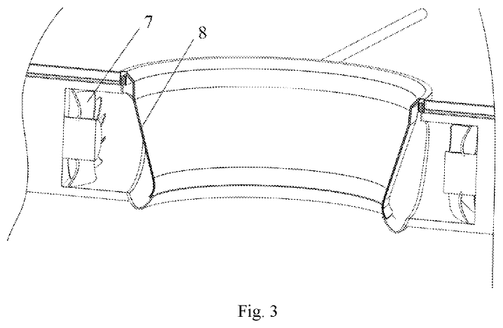

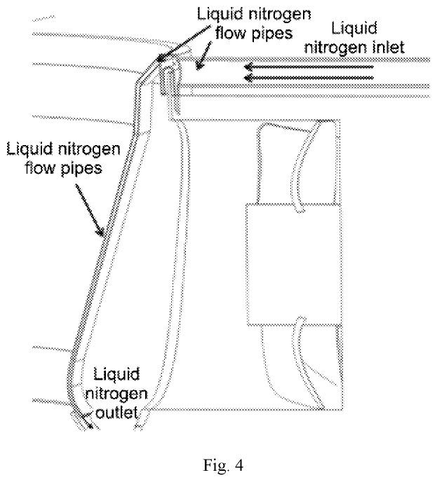

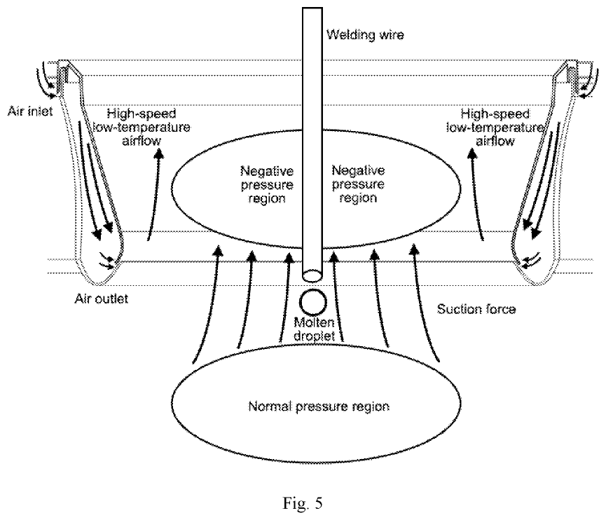

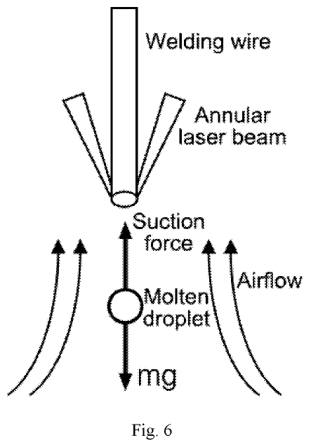

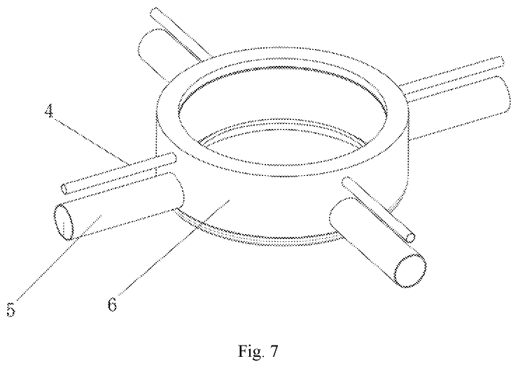

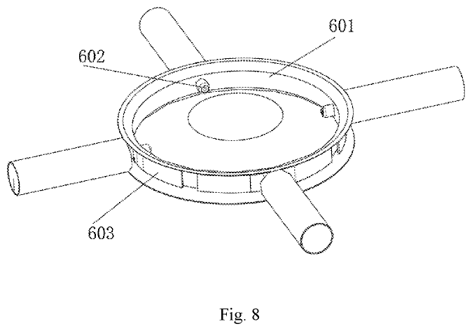

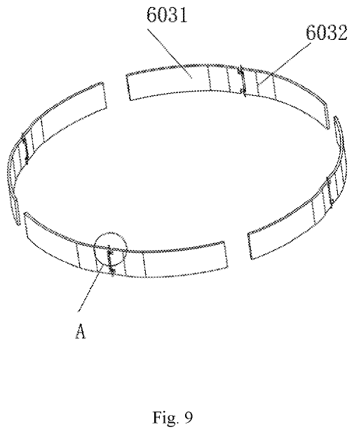

Referring to FIGS. 1-9, the present disclosure provides a device for laser coaxial wire additive manufacturing in a simulated microgravity environment. The device includes a main body and a coaxial wire-feeding head 1. A negative pressure suction structure 6 is provided on a wire feeding nozzle of the coaxial wire-feeding head 1. An outer side of a top of the negative pressure suction structure 6 is provided with a plurality of liquid nitrogen flow pipes 4, and the negative pressure suction structure 6 is configured to be connected with an external cooling source through the plurality of liquid nitrogen flow pipes 4. A plurality of gas flow pipes 5 are respectively provided at two sides of the negative pressure suction structure 6. The top of the negative pressure suction structure 6 is fixedly connected with a cooling shell 3 through the plurality of gas flow pipe 5. The cooling shell 3 communicates with an interior of the negative pressure suction structure 6 through the plurality of gas flow pipe 5.

An interior of each of the plurality of gas flow pipe 5 is provided with a fan 7, and the fan 7 is configured to generate an airflow. An inner wall of the negative pressure suction structure 6 opposite to the fan 7 is provided with a curved cross-sectional structure 8, and the curved cross-sectional structure 8 is configured to generate an enhanced and uniform annular upward airflow at a center of the fan 7 due to a pressure difference, so as to balance a gravity of a molten droplet falling from a welding wire.

In an embodiment, the number of the plurality of liquid nitrogen flow pipes 4 is four, and four liquid nitrogen flow pipes 4 are arranged on an outer side of the negative pressure suction structure 6 in a circular array; the external cooling source is cooled nitrogen, and is configured to be introduced into the interior of the negative pressure suction structure 6 through the four liquid nitrogen flow pipes 4 for cooling. The cooled nitrogen also is capable of acting as a protective gas.

In an embodiment, an air inlet and an air outlet are provided on the negative pressure suction structure 6. Compressed air is configured to be allowed to enter through the air inlet, pass through a special flow channel inside the negative pressure suction structure, and flows out through the air outlet. A flow velocity at the air outlet is greatly increased so as to achieve the Bernoulli negative-pressure principle.

In an embodiment, a portion of a bottom of the negative pressure suction structure 6 close to an inner side of the negative pressure suction structure 6 is provided with a cooled nitrogen outlet. The cooled nitrogen outlet is configured to be upwardly inclined to generate the high-speed airflow, so as to generate a negative pressure region.

In an embodiment, the interior of the negative pressure suction structure 6 is provided with an arc-shaped partition 601. The arc-shaped partition 601 is configured to divide the negative pressure suction structure 6 into two regions. The arc-shaped partition 601 is provided with a plurality of pressure nozzles 602. The plurality of pressure nozzles 602 are respectively matched with the plurality of gas flow pipe 5 in number and position.

In an embodiment, an outer side of the arc-shaped partition 601 is provided with a plurality of airflow regulating assemblies 603. The plurality of airflow regulating assemblies 603 are arranged between the plurality of pressure nozzles 602 and the gas flow pipe 5, respectively.

In an embodiment, each of the plurality of airflow regulating assemblies 603 includes a first flow guide plate 6031 and a second flow guide plate 6032 movably connected with each other, and the first flow guide plate 6031 and the second flow guide plate 6032 are movably connected with an inner wall of the arc-shaped partition 601 through a rotating shaft 6034 in. A spring 6033 is sleeved outside the rotating shaft 6034. A first end of the spring 6033 is connected with the first flow guide plate 6031, and a second end of the spring 6033 is connected with the second flow guide plate 6032.

### Embodiment 1

The negative pressure suction structure is started. A liquid nitrogen flow is introduced to generate an initial negative pressure field. An airflow parameter for balancing gravity is determined according to properties of used materials, where the used materials are selected from aluminum, titanium and steel. A coaxial wire-feeding unit 2, a camera, and an infrared thermal imager are adjusted, where devices here are directly installed from the prior art and are commonly available in laser coaxial wire additive manufacturing devices thus not explained in detail. A substrate is fixed. Parameters of laser coaxial wire additive manufacturing are determined, where the parameters include a laser power, a scanning speed, a wire-feeding speed and a focal length during a process of the laser coaxial wire additive manufacturing. Laser beams are focused onto the substrate to form a molten pool. A metal wire is fed into a center of the molten pool to achieve droplet transfer and spreading in a microgravity environment simulated by a negative pressure suction field. After single-track cladding is completing, a motion platform moves according to a preset path, and a laser head synchronously adjusts its position to perform additive manufacturing at a next track or next layer. The camera captures processes of droplet detachment, droplet spreading and droplet solidification in real time, where the camera herein is a high-speed camera and is directly installed from the prior art, thus not described in detail. The infrared thermal imager monitors a temperature field distribution of the molten pool. After a target structure is formed by layer-by-layer stacking, a laser and wire-feeding system is turned off. The negative pressure suction field is maintained until the molten pool is completely solidified. Differences in droplet detachment frequency, spreading radius, and solidification morphology between microgravity and normal gravity are compared and analyzed, and forming quality and performance are analyzed. In the whole process of the present disclosure, based on Bernoulli's principle, an annular negative pressure suction field is generated in a vertical direction to balance gravity in real time, enabling long-duration, continuous, low-cost, and realistic simulation of laser wire additive manufacturing in the microgravity environment. The present disclosure includes a device integrating liquid nitrogen cooling and protective gas flow, which can counteract effects of thermal expansion caused by high temperature generated by laser heating on airflow disturbance and deformation of the negative pressure suction structure, and can also replace side-blown protective gas device to prevent oxidation during the additive manufacturing process, thereby significantly reducing the cost of experimental verification for additive manufacturing in the microgravity environment.

### Embodiment 2

On the foundation of Embodiment 1, the arc-shaped partition 601 is provided, such design is applied in special situations. When leakage occurs in the fan or channel of one of the plurality of gas flow pipes 5, in order to maintain a relatively balanced negative pressure region around the molten droplet within the negative pressure suction structure 6, the present disclosure provides the arc-shaped partition 601, and utilizes the arc-shaped partition 601 to isolate the plurality of gas flow pipes 5 and the gas outlet on the bottom of the negative pressure suction structure 6, allowing a side of the arc-shaped partition 601 to pre-charge the airflow. When the pressure is satisfied, the plurality of pressure nozzles 602 automatically eject gas. In such situation, the plurality of pressure nozzles 602 eject gas at equal pressure. When one gas flow pipe 5 is cutoff, the plurality of airflow regulating assemblies 603 can be utilized. The plurality of airflow regulating assemblies 603 will be forced to bend when corresponding gas flow pipes 5 are inflated. When one of the corresponding gas flow pipes 5 is cutoff, the first flow guide plate 6031 and the second flow guide plate 6032 of the one of the corresponding gas flow pipes are reset by a spring restoring force, so that the first flow guide plate 6031 and the second flow guide plate 6032 on the plurality of airflow regulating assemblies 603 on opposite sides of the one of the corresponding gas flow pipes 5 that are not cutoff are pressed against the inner wall of the arc-shaped partition, directing the airflow to an inner side of reset first flow guide plate 6031 and reset second flow guide plate 6032, that is, the airflow is directly directed to a pressure nozzle 602 corresponding to the cutoff gas flow pipe for pressure compensation, thereby preventing unequal pressure among the plurality of pressure nozzles 602 even when one gas flow pipe is cut off.

It should be noted that described above are only preferred embodiments of this application, which are not intended to limit this application. Although the present disclosure has been described in detail with reference to the embodiments, for those skilled in the art, various modifications and equivalent replacement of part of technical characteristics can also be made in the technical solutions. Any modifications, equivalent replacements and improvements made within the spirit and principle of this application shall fall within the scope of this application defined by the appended claims.

What is claimed is:

1. A device for laser coaxial wire additive manufacturing in a simulated microgravity environment, comprising:
a main body; and
a coaxial wire-feeding head;
wherein a negative pressure suction structure is provided on a wire feeding nozzle of the coaxial wire-feeding head; an outer side of a top of the negative pressure suction structure is provided with a plurality of liquid nitrogen flow pipes, and the negative pressure suction structure is configured to be connected with an external cooling source through the plurality of liquid nitrogen flow pipes; a plurality of gas flow pipes are respectively provided at two sides of the negative pressure suction structure; the top of the negative pressure suction structure is fixedly connected with a cooling shell through the plurality of gas flow pipes; and the cooling shell communicates with an interior of the negative pressure suction structure through the plurality of gas flow pipes;
an interior of each of the plurality of gas flow pipes is provided with a fan, and the fan is configured to generate an airflow; an inner wall of the negative pressure suction structure opposite to the fan is provided with a curved cross-sectional structure, and the curved cross-sectional structure is configured to generate an enhanced and uniform annular upward airflow at a center of the fan due to a pressure difference, so as to balance a gravity of a molten droplet falling from a welding wire; and
the interior of the negative pressure suction structure is provided with an arc-shaped partition; the arc-shaped partition is configured to divide the negative pressure suction structure into two regions; the arc-shaped partition is provided with a plurality of pressure nozzles; and the plurality of pressure nozzles are respectively matched with the plurality of gas flow pipes in number and position; an outer side of the arc-shaped partition is provided with a plurality of airflow regulating assemblies; and the plurality of airflow regulating assemblies are arranged between the plurality of pressure nozzles and the plurality of gas flow pipes, respectively; each of the plurality of airflow regulating assemblies comprise a first flow guide plate and a second flow guide plate movably connected with each other; and the first flow guide plate and the second flow guide plate are movably connected with an inner wall of the arc-shaped partition through a rotating shaft; a spring is sleeved outside the rotating shaft, and a first end of the spring is connected with the first flow guide plate, and a second end of the spring is connected with the second flow guide plate.

2. The device of claim 1, wherein the number of the plurality of liquid nitrogen flow pipes is four, and four liquid nitrogen flow pipes are arranged on an outer side of the negative pressure suction structure in a circular array; the external cooling source is cooled nitrogen, and is configured to be introduced into the interior of the negative pressure suction structure through the four liquid nitrogen flow pipes for cooling; and the cooled nitrogen is capable of acting as a protective gas.

3. The device of claim 2, wherein a portion of a bottom of the negative pressure suction structure close to an inner side of the negative pressure suction structure is provided with a cooled nitrogen outlet; and the cooled nitrogen outlet is configured to be upwardly inclined to generate the airflow, so as to generate a negative pressure region.

4. A method for operating the device of claim 3, wherein the method comprises:
(S1) starting the negative pressure suction structure and the fan provided in the negative pressure suction structure; introducing an external liquid nitrogen flow into the four liquid nitrogen flow pipes, so as to generate an initial negative pressure field; and determining an airflow parameter for balancing gravity according to properties of used materials;
(S2) adjusting a coaxial wire-feeding unit, a camera, and an infrared thermal imager; fixing a substrate; and determining parameters of laser coaxial wire additive manufacturing;
(S3) focusing laser beams onto the substrate to form a molten pool; feeding a metal wire into a center of the molten pool to achieve droplet transfer and spreading in a microgravity environment simulated by a negative pressure suction field;
(S4) capturing, by the camera, processes of droplet detachment, droplet spreading and droplet solidification in real time; and monitoring, by the infrared thermal imager, a temperature field distribution of the molten pool; and
(S5) after a target structure is formed by layer-by-layer stacking, turning off a laser and wire-feeding system; and maintaining the negative pressure suction field until the molten pool is completely solidified.
